(19) United States
(12) Patent Application Publication
(10) Pub. No.: US 2003/0224716 A1
(43) Pub. Date: Dec. 4, 2003

(54) Slot machine coin bag

(76) Inventors: Christine Angela Manfre-Mooney, Staten Island, NY (US); David James Palmieri, Staten Island, NY (US)

Correspondence Address: Salvatore J. Maiorino, 827 Hylan Blvd., Staten Island, NY, 10305, US

(21) Appl. No.: 10/364,151

(22) Filed: Feb. 11, 2003

Related U.S. Application Data
(60) Provisional application No. 60/356,243, filed on Feb. 12, 2002.

(51) Int. Cl. G07D 9/00

(52) U.S. Cl. 453/63

(57) ABSTRACT

A slot machine coin bag with an outer rim and means for closing the outer rim is sized to fit the interior of a slot machine coin tray. As a gambling patron plays, coins land in the bag and when finished, the patron closes the bag, securing the coins therein, picks up the bag with his winnings and moves to the next machine. The bag is placed in the tray, opened, and the process repeated.

### CROSS-REFERENCE TO RELATED APPLICATION

This application clams the benefit of U.S. Provisional Patent Application No. ______ filed Feb. 12, 2002, the entire disclosure of which is hereby incorporated by reference.

### BACKGROUND

Gambling establishments customarily supply coin cups to their patrons for holding slot machine coins. Typically, a user will take the cup, fill it with a number of coins, and use those coins to play on slot machines. When the patron of the gambling establishment wins at the slot machine, the slot machine will expel numerous coins, the quantity of which depends on the particular win. Coins are then gathered up and placed in the coin cup by the winning patron and either spent again at the slot machine or other gambling tables, or kept by the patron as his winnings. In any case, the coin cup has become the means by which patrons of gambling institutions carry around their coins.

### SUMMARY OF THE INVENTION

The present invention provides a slot machine coin bag comprising a bag sized to fit the interior of a slot machine coin tray. The bag has an outer rim with means for constricting the rim. Constriction of the rim closes the bag to securely hold slot machine coins contained therein.

### BRIEF DESCRIPTION OF THE DRAWINGS

FIG. 1 shows a slot machine coin bag according to an embodiment of the present invention.

FIG. 2 shows the bag of FIG. 1 in a closed configuration.

FIG. 3 shows an alternative embodiment of the bag in FIG. 1.

FIG. 4 shows a further alternative embodiment of the slot machine coin bag.

### DETAILED DESCRIPTION

Even though the coin cup makes it easier to carry around coins as compared with, for example, having to carry the coins in one's hand or one's pockets, the coin cup still has many inadequacies. For example, the coins carried in the coin cup become a heavy burden when carried by the user for a prolonged period of time. Also, because the coin cups of various individuals are identical, there is always the danger that one will set down his cup next to another individual's and unintentionally pick up the wrong cup. Furthermore, patrons carrying around coin cups may be subject to pilfering by unscrupulous individuals at the gambling establishment who intentionally pick up the wrong cup when the cup is set down while the player rests his arms or is preoccupied with spinning symbols. In any event, absolute control of the contents of a discrete portable cup is iffy at best.

Furthermore, gambling patrons must scoop or pick their winnings out of the slot machine coin tray by hand, usually causing damage to nails and fingertips. This physical contact with the coins is undesirable for sanitary reasons as well. Coins are dirty, germ-ridden and full of bacteria.

In addition, gambling establishments often wish to promote themselves with inexpensive items which may be used by the patrons of the establishment and later kept as a memento or thrown away. It is therefore desirable that such items have some imprinting on them which affiliates the item with the particular gambling establishment or for some other promotional reason. These gambling establishments also give away such items to their patrons, in which case the cost associated with each item is of particular importance and must be kept to a reasonable minimum. Additionally, such an item should have some useful purpose pertaining to the gambling experience and ideally will have a positive effect on the patron by, for example, reducing the fatigue associated with performing the gambling activity.

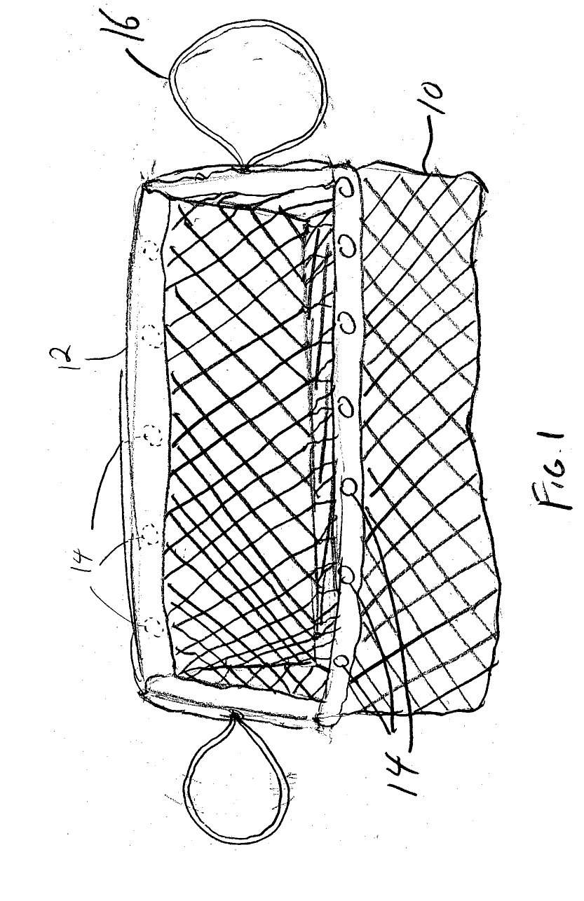

FIG. 1 depicts a coin bag in accordance with an embodiment of the present invention. A net 10 is attached to an upper rim 12. The upper rim has means for attaching to the interior of a slot machine coin tray. In this particular embodiment shown, there are a plurality of magnets 14 disposed along the length of the rim 12 to attach to the metallic surface of a coin tray interior. In alternative embodiments, clips may be used instead of, or in addition to the magnets. Suction cups are a possible alternative as well. A drawstring 16 runs through the interior of the upper rim 12 to act as both a handle and as means for closing the rim 12 to secure the contents of the net 10.

The net is placed in a slot machine coin tray, covering a portion of the tray interior. Preferably, the net covers at least half of the tray. The upper rim is placed against the tray upper rim and secured by the magnetic attraction between the magnets and the metallic tray. As the slot machine dispenses coins, they fall into the net of the bag. When a player decides to move on, he or she pulls on the drawstring to close the bag and detach the magnets, picks the bag up out of the tray, and moves to the next machine.

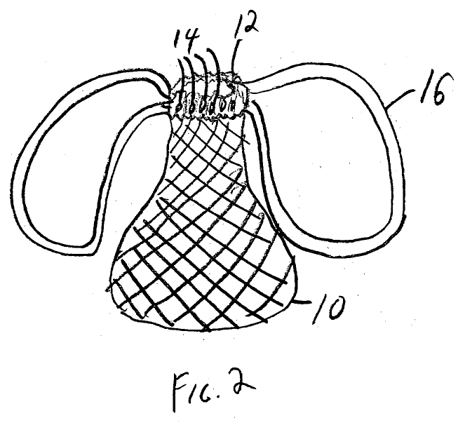

FIG. 2 shows the bag of FIG. 1 in a closed configuration with the drawstrings 16 pulled, thereby constricting the rim 12 to close on the net 10 and securing any coins contained therein.

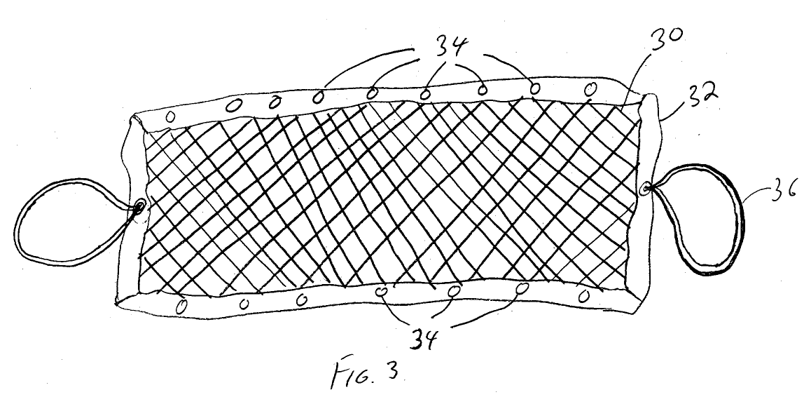

FIG. 3 shows an alternative embodiment of the present invention with a substantially flat net 30. A rim 32 is stitched to the outer edge of the net 30 along its perimeter. Means for attaching the rim 34 to a slot machine tray are provided on the net rim 32. Means for attaching the rim 34 may be magnets, suction cups, clips, or an elastic band sized to fit around upper lip of the coin tray. A drawstring 36 is provided so that pulling on the string 36 closes the rim 32 around the net 30, securing the contents contained therein, in the same fashion as the embodiment described in FIGS. 1-2.

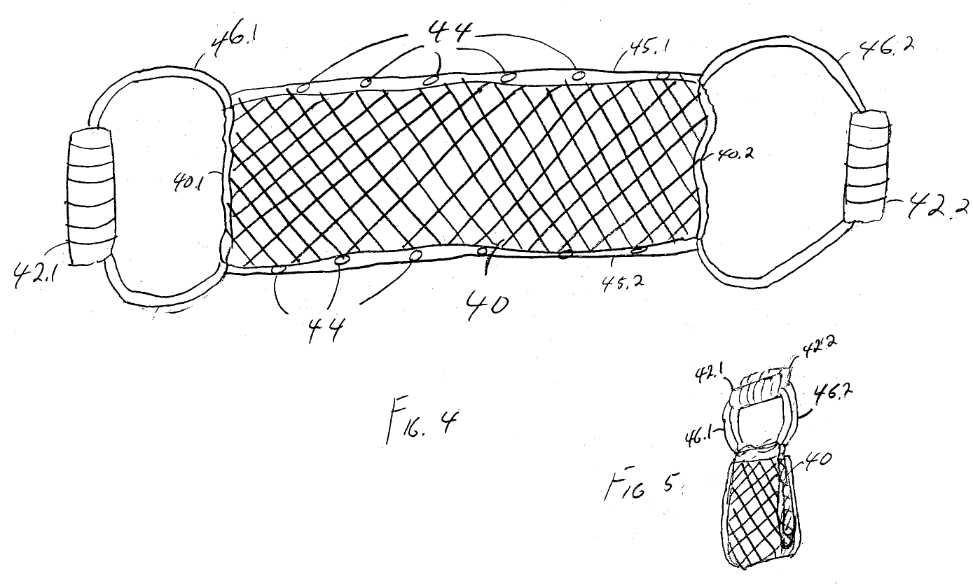

Referring to FIG. 4, another alternative embodiment of a coin bag in accordance with the present invention is shown. A substantially flat net 40 is surrounded by a rim 45.1 on one side and another rim 45.2 on the opposite side. Each rim has meas for attaching 44 to a slot machine coin tray. A string or cord 46.1 runs through one side 40.1 of the net and another string or cord 42.2 runs through the opposite side 40.2 of the net. Each cord 46.1 and 46.2 has a handle 42.1 and 42.2 around a portion of its length.

FIG. 5 shows the coin bag of FIG. 4 in a closed position. The handles 42.1 and 42.2 are brought together to take a sling-like form, cradling the bags in the bottom of the sling formed by the net 40.

The handles provide an added benefit and advantage for senior people with arthritis, hands generally weakened by old age, or those with over-sized hands that typically have problems picking up small items, like coins. Without the bag, they would have to scoop the coins out of the tray. With the handled-bag, they simply pick the bag up by the handles, thereby removing the coins from the tray without having to actually contact the coins. Less direct handling of the coins provides improved hygenic benefits as well.

The bag is placed in a slot machine coin tray, covering a portion of the tray interior. Preferably, the net covers at least half of the tray. The upper rim of the bag is secured onto the upper rim of the coin tray by the means for attaching to the coin tray rim included in the net rim, which may be magnets, clips, suction cups, or an elastic band as previously discussed. As the slot machine dispenses coins, they fall into the net of the bag. When a player decides to move on, he or she pulls on the drawstring or handles, depending on the embodiment being used, to close the bag, detach the means for attaching, pick the bag up out of the tray, and move to the next machine.

The bag may be made from any material strong enough to hold at least approximately fifty coins. This includes nylon, canvas, and plastic. The means for closing the bag may be changed as well to accommodate the bag material. For example, a zip closure for a plastic bag, or a zipper for a canvas bag. The exact configuration of the bag, i.e., combination of material and closing means, is a design choice and all combinations are well within the scope of the invention.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A slot machine coin bag comprising:
a bag sized to fit the interior of a slot machine coin tray, the bag having an outer rim;
means for constricting on the outer rim constructed and arranged to constrict the outer rim;
wherein the constriction of the outer rim closes the bag to securely hold slot machine coins contained therein.

2. The bag of claim 1 wherein the bag is a net.

3. The bag of claim 1 wherein the bag is plastic.

4. The bag of claim 1 wherein the bag is canvas.

5. The bag of claim 1 wherein the means for constricting is a drawstring.

6. The bag of claim 1 wherein the means for constricting is a zip closure.

7. The bag of claim 1 wherein the outer rim further comprises means for attaching the rim to the interior of a slot machine coin tray.

8. The bag of claim 6 wherein the means for attaching are magnets.
